(19) United States
(12) Patent Application Publication
(10) Pub. No.: US 2019/0247830 A1
(43) Pub. Date: Aug. 15, 2019

(54) CATALYST CARRIER AND CATALYST COMPRISING SAME

(71) Applicant: HighChem Technology Co., LTD., Tokyo (JP)

(72) Inventors: Jianyu CHAI, Tokyo (JP); Kennin SO, Tokyo (JP); Huaduan ZHAN, Tokyo (JP); Yongye LI, Tokyo (CN)

(21) Appl. No.: 16/335,020

(22) PCT Filed: Sep. 20, 2016
(86) PCT No.: PCT/CN2016/099483

§ 371 Date: Mar. 20, 2019

(51) Int. Cl. B01J 21/04; B01J 23/89; B01J 37/02; B01J 37/06; B01J 37/18; B01J 35/08; B01J 37/10; B01J 35/10; B01J 35/00

(52) U.S. Cl. CPC B01J 21/04; B01J 23/8906; B01J 37/0213; B01J 37/06; B01J 37/0236; B01J 35/0026; B01J 35/08; B01J 37/10; B01J 35/1076; B01J 35/1009; B01J 37/18

(57) ABSTRACT

The present application relates to a catalyst carrier for use in the synthesis of dialkyl oxalates by gas-phase catalytic coupling of carbon monoxide comprising microscopic fine pores and one or more macroscopic large pores running through the catalyst carrier, wherein the ratio of the average pore diameter of each macroscopic large pore to the average diameter of the catalyst carrier is 0.2 or more. The present application also relates to a catalyst, comprising the catalyst carrier, an active component and an optional auxiliary, supported on the catalyst carrier. The catalyst according to the present invention not only catalyze effectively coupling of carbon monoxide in a gas phase to form dialkyl oxalate, but also improves heat dissipation, reduces pressure drop, reduces the amount applied of precious metal such as palladium, thereby reducing the use cost of the catalyst and production cost of dialkyl oxalate and then facilitating industrial mass production of dialkyl oxalate.

### TECHNICAL FIELD

The present invention relates to a catalyst carrier for use in the synthesis of dialkyl oxalate by gas-phase catalytic coupling of carbon monoxide, and a catalyst comprising the catalyst carrier for the synthesis of dialkyl oxalate by gas-phase catalytic coupling of carbon monoxide.

### BACKGROUND ART

The formation of dialkyl oxalate by coupling of carbon monoxide is a rapid, highly exothermic reaction, which requires the use of a suitable catalyst to ensure safe production. Current catalysts generally use spherical alumina having micropores, mesopores, and/or macropores as a support, which is supported thereon with a noble metal such as palladium. This catalyst has advantages of easy packing, uniform stacking, high and uniform heat dissipation, and easy recovery of precious metals after use.

However, in recent years, the enlargement of equipment puts forward higher requirements on catalyst, and in particular, requires high heat dissipation, low pressure drop, low palladium content, low by-products, and low cost of use.

Chinese patent application for invention No. 201010191580.9 uses a honeycomb carrier, which reduces pressure drop and reduces palladium content. However, the honeycomb carrier is not good for heat dissipation, and it easily causes run-away of temperature.

Chinese patent application for invention No. 201110131440.7 uses a carrier with a framework of metal wire mesh, which improves heat dissipation, lowers pressure drop, and reduces palladium content. However, the material of the carrier is expensive and the processing is complicated. After the catalyst is used, the precious metal is not easily recovered, resulting in a significantly higher cost of use.

At present, there is no catalyst that can sufficiently satisfy the requirements for the preparation of dialkyl oxalate by gas-phase catalytic coupling of carbon monoxide in large-scale equipment.

### SUMMARY OF INVENTION

In view of the above situation in the prior art, the inventors of the present application conducted intensive and extensive studies in the field of synthesis of dialkyl oxalate by gas phase catalytic coupling of carbon monoxide in order to find a catalyst that can fully satisfy the requirements for the preparation of dialkyl oxalate by gas-phase catalytic coupling of carbon monoxide in large-scale equipment, which not only can effectively perform gas-phase catalytic coupling of carbon monoxide to produce dialkyl oxalate, but also is suitable for use in large-scale equipment. It has been found that the above objects can be achieved by the use of a catalyst carrier having one or more macroscopic large pores that run through the catalyst carrier. The present inventors have completed the present invention based on the findings above.

Accordingly, one object of the present invention is to provide a catalyst carrier for use in the synthesis of dialkyl oxalate by gas-phase catalytic coupling of carbon monoxide .

Another object of the present invention is to provide a catalyst for use in the synthesis of dialkyl oxalate by gas-phase catalytic coupling of carbon monoxide.

The technical solutions that achieve the above objects of the present invention can be summarized as follows:

1. A catalyst carrier for use in the synthesis of dialkyl oxalates by gas-phase catalytic coupling of carbon monoxide comprising microscopic fine pores and one or more macroscopic large pores running through the catalyst carrier, wherein the ratio of the average pore diameter of each macroscopic large pore to the average diameter of the catalyst carrier is 0.2 or more.

2. The catalyst carrier of item 1, wherein the catalyst carrier has one macroscopic large pore which runs through the catalyst carrier in the form of a straight line.

3. The catalyst carrier of item 1 or 2, wherein the ratio of the average pore diameter of each macroscopic large pore to the average diameter of the catalyst carrier is from 0.5 to 0.8.

4. The catalyst carrier of any of items 1-3, wherein the macroscopic large pore has a circular or elliptical cross-section.

5. The catalyst carrier of any of items 1-4, wherein the catalyst carrier is spherical or ellipsoidal.

6. The catalyst carrier of any of items 1-5, wherein the catalyst carrier has an average diameter of from 1 to 20 mm.

7. The catalyst carrier of any of items 1-6, wherein the catalyst carrier is made of α-alumina, γ-alumina, silica, silicon carbide, diatomaceous earth, activated carbon, pumice, zeolites, molecular sieves, or titanium dioxide.

8. A catalyst for use in the synthesis of dialkyl oxalates by gas-phase catalytic coupling of carbon monoxide comprising a catalyst carrier according to any of items 1-7, an active component and optionally an auxiliary, supported on the catalyst carrier.

9. The catalyst of item 8, wherein the active component is palladium, platinum, ruthenium, rhodium and/or gold, and wherein the auxiliary is iron, nickel, cobalt, cerium, titanium and/or zirconium.

10. The catalyst of item 8 or 9, wherein the active component is in an amount of from 0.1 to 10% by weight, preferably from 0.1 to 1% by weight, and wherein the auxiliary is in an amount of from 0 to 5% by weight, preferably from 0.05 to 0.5% by weight, based on the total weight of the catalyst.

By using a catalyst carrier having one or more macroscopic large pores and restricting the active component mainly on the outer surface of the catalyst carrier and the inner surface of the macroscopic large pores which have high fluidity and diffusibility, the present invention not only effectively produces dialkyl oxalate by gas-phase catalytic coupling of carbon monoxide, but also increases heat dissipation, reduces pressure drop, and reduces the amount of precious metals such as palladium, which in turn lowers the cost of the catalyst and production cost of dialkyl oxalate and facilitates large-scale industrial production of dialkyl oxalate.

These and other objects, features, and advantages of the present invention will become apparent to those skilled in the art upon consideration of the present invention as a whole.

### DETAILED DESCRIPTION OF INVENTION

### Catalyst Carrier

The present invention firstly provides a catalyst carrier having microscopic fine pores and one or more macroscopic large pores running through the catalyst carrier.

According to the definition of the International Union of Pure and Applied Chemistry (IUPAC), pores with a pore diameter of less than 2 nanometers are called micropores; pores with a pore diameter of more than 50 nanometers are called macropores; pores with a pore diameter of between 2 and 50 nanometers are called mesopores. In the context of the present invention, “microscopic fine pores” refers to micropores, mesopores and macropores as defined by the IUPAC, which are formed naturally during the preparation of the catalyst carrier.

In the context of the present invention, “macroscopic large pore” is opposite to the “microscopic fine pore” as defined above, and thus does not include micropores, mesopores and macropores as defined by the IUPAC, and is specially formed during the preparation of the catalyst carrier.

As understood by those skilled in the art, “run through” means that one macroscopic large pore, or multiple macroscopic large pores, independently of each other, penetrate through the entire catalyst carrier, and are in communication with air through both ends of the macroscopic large pore, respectively, so that a material flow path, such as a gas flow path or a liquid flow path, is formed within the catalyst carrier.

In the present invention, the pore diameters and numbers of the microscopic fine pores, i.e., micropores, mesopores and macropores, are conventional in the catalyst field, and therefore, they are not specifically defined. As for the lower limit of pore diameter of the micropores and the upper limit of pore diameter of the macropores, they are also conventional in the catalyst field and are well known to those skilled in the art.

The catalyst carrier of the present invention may have one or more, for example, from 2 to 8 macroscopic large pores, preferably 1, 2, 3, 4, or 5 macroscopic large pores, more preferably 1, 2, or 3 macroscopic large pores, particularly preferably 1 or 2 macroscopic large pores, and most preferably one macroscopic large pore.

The one or more macroscopic large pores, independently of one another, may run through the entire catalyst carrier in the form of a polygonal, curved or straight line, preferably in a straight line.

Preferably, the catalyst carrier of the present invention has one macroscopic large pore which runs through the catalyst carrier in the form of a straight line.

Macroscopic large pores may have any suitable cross-sectional shape. In view of the ease of preparation and catalytic effect, it is preferred that the macroscopic large pores have a circular or elliptical cross-section.

The catalyst carrier of the invention may be of any suitable shape, preferably spherical or ellipsoidal.

The ratio of the average pore diameter of the macroscopic large pore of the catalyst carrier to the average diameter of the catalyst carrier of the present invention is 0.2 or more, preferably from 0.5 to 0.8. When the macroscopic large pore has an elliptical cross-section, the average pore diameter is defined as the average of the major axis and the minor axis of the ellipse. When the catalyst carrier is ellipsoidal, the average diameter is defined as the average of the three, that is, two equatorial diameters and one polar diameter of the ellipsoid.

In a preferred embodiment of the present invention, the catalyst carrier of the present invention is spherical or ellipsoidal, and has one macroscopic large pore which runs through the catalyst carrier in the form of a straight line with any diameter of the sphere or ellipsoid as the central axis, and the macroscopic large pore has a circular or elliptical cross-section.

The catalyst carrier of the invention has an average diameter of from 1 to 20 mm.

According to the ratio of the average pore diameter of the macroscopic large pore to the average diameter of the catalyst carrier as described above, the average diameter of the macroscopic large pore of the catalyst carrier of the present invention is correspondingly from 0.2 to 10 mm, preferably from 0.5 to 5 mm.

The catalyst carrier of the present invention can be made of any material suitable for the synthesis of dialkyl oxalate by gas-phase catalytic coupling of carbon monoxide, such as α-alumina, γ-alumina, silica, silicon carbide, diatomaceous earth, activated carbon, pumice, zeolites, molecular sieves or titanium dioxide, preferably α-alumina.

### Preparation Method of Catalyst Carrier

Taking a spherical catalyst carrier having a macroscopic large pore with a circular cross-section as an example, the preparation method thereof generally comprises the following steps: kneading powder of raw materials, extruding into hollow cylinders with an inner diameter/outer diameter ratio of greater than 0.2, followed by pelletizing, rounding, drying, and calcination to obtain a catalyst carrier having microscopic fine pores and a macroscopic large pore which runs through the catalyst carrier in the form of a straight line. During the kneading, dilute nitric acid or acetic acid may be used. The above steps are conventional in the catalyst field and are well known to those skilled in the art. The pelletizing and rounding can be performed, for example, by a pelletizer with a rolling cutter. Drying is preferably carried out, for example, at a temperature of from 90 to 150° C., especially from 100 to 130° C. The calcination temperature of the catalyst carrier varies, for example, between 1,150 and 1,350° C., depending on the raw materials.

A person skilled in the art can easily prepare catalyst carriers of other shapes comprising macroscopic large pores having other cross-sectional shapes after making appropriate changes to the above preparation method.

The catalyst carrier according to the invention is suitable for use as a catalyst carrier in the synthesis of dialkyl oxalates by gas-phase catalytic coupling of carbon monoxide.

### Catalyst

The present invention also provides a catalyst for use in the synthesis of dialkyl oxalate by gas-phase catalytic coupling of carbon monoxide, the catalyst comprising: the above catalyst carrier of the present invention, an active component and optionally an auxiliary, supported on the catalyst carrier.

As for the active component, any active component suitable for the synthesis of dialkyl oxalates by gas-phase catalytic coupling of carbon monoxide can be used, for example, palladium, platinum, ruthenium, rhodium and/or gold; the preferred active component is palladium.

As for the auxiliary, any auxiliary suitable for the synthesis of dialkyl oxalates by gas-phase catalytic coupling of carbon monoxide can be used, for example, iron, nickel, cobalt, cerium, titanium and/or zirconium; the preferred auxiliary is iron.

The active ingredient is in an amount of from 0.1 to 10% by weight, preferably from 0.1 to 1% by weight, and the auxiliary is in an amount of from 0 to 5% by weight, preferably from 0.05 to 0.5% by weight, based on the total weight of the catalyst.

### Preparation Method of Catalyst

The catalyst of the present invention may be prepared by an excess impregnation method or an equal volume impregnation method. As for the excess impregnation method, reference can be made to the “PREPARATION EXAMPLES OF SOLID CATALYST” section of U.S. Pat. No. 4,874,888, which is incorporated herein by reference. As for the equal volume impregnation method, it is carried out with reference to the above-mentioned excess impregnation method, based on water absorption rate of the catalyst carrier and the required amounts of active component loaded and auxiliary.

### Application of Catalyst

The catalyst of the invention is suitable for the synthesis of dialkyl oxalates by gas-phase catalytic coupling of carbon monoxide. The dialkyl oxalates can be di(C₁₋₄ alkyl) oxalates, such as dimethyl oxalate, diethyl oxalate, di-n-propyl oxalate, diisopropyl oxalate and di-n-butyl oxalate, with dimethyl oxalate and diethyl oxalate being preferred. Correspondingly, methyl nitrite and ethyl nitrite are preferably used as starting materials for the reaction. The specific conditions for the reaction of carbon monoxide with nitrite to form dialkyl oxalates, such as reaction temperature, time and pressure, are well known to those skilled in the art. Specific information can be found in Chinese patent applications for inventions CN 1218032 A and CN 1445208 A, both of which are incorporated herein by reference.

The catalyst of the present invention has the following advantages:

1. Easy loading, uniform packing; high and uniform heat dissipation; and reduced pressure drop;

2. Small dose of precious metals, and low cost of use;

3. High space velocity, high time-space yield; high single-pass conversion rate; high dialkyl oxalate selectivity, and low by-products;

4. Easy recovery of precious metals after use; and

5. Suitable for large-scale industrial production of dialkyl oxalates.

### EXAMPLES

Hereinafter, the present invention will be specifically described by referring to the examples, but the examples are not construed to limit the scope of the present invention.

The specific surface area is determined by the multipoint BET method. The water absorption rate is determined by the following method: 3 g of the carrier is weighed, and soaked in water of 90° C. for 1 hour, then taken out, dried with wiping and weighed. The water absorption rate of the carrier is calculated according to the following formula: W=(B−G)/G×100%, where W is the water absorption rate, G is the initial weight of the carrier, and B is the weight of the carrier after soaking in water for 1 hour. The amounts of palladium and iron loaded are determined by ICP atomic emission spectrometry, for example, by means of an inductively coupled plasma-atomic emission spectrometer. The time-space yield and selectivity of dimethyl oxalate are determined by gas chromatography analysis.

### Example 1

### Preparation of Catalyst Carrier

Pseudoboehmite having a purity of 99.99% and a specific surface area of 310 m²/g was wetted with an aqueous solution of 1 wt % nitric acid, kneaded and extruded into hollow cylinders having an inner diameter of 4.6 mm and an outer diameter of 6.5 mm. Next, the hollow cylinders were pelletized and rounded using a pelletizer with a rolling cutter to make spheres having a macroscopic large pore running through the two ends of the carrier. The hollow spheres were dried at 120° C. overnight, and calcined at 1250° C. for 8 hours to obtain the catalyst carrier of the present invention, namely a hollow spherical α-alumina carrier having microscopic fine pores and one macroscopic large pore which runs through the two ends of the carrier in the form of a straight line with a diameter of the sphere as the central axis, wherein the average diameter of the carrier is 5 mm, the average pore diameter of the macroscopic large pore is 3.5 mm, the average pore diameter/average diameter ratio is 0.7, the specific surface area of the carrier is 5.3 m²/g, the water absorption rate is 30.1 wt %, and the packing density is 0.51 kg/L.

### Preparation of Catalyst

50 g of the inventive catalyst carrier of Example 1 was impregnated in an equal volume for 2 hours with a mixed impregnating solution prepared by dissolving 0.21 g of palladium chloride and 0.31 g of ferric chloride hexahydrate in 14.5 g of water and 0.12 g of 61% hydrochloric acid with heating, subsequently impregnated in 50 g of an aqueous solution of 1N sodium hydroxide with stirring for 4 hours at 60° C. for alkali treatment, washed with deionized water until the washing liquor was free of chloride ions by silver nitrate detection, completely dried in a drying oven at 120° C., transferred to a quartz glass tube having an inner diameter of 20 mm, and subjected to a reduction treatment with a stream of hydrogen gas at 500° C. for 3 hours to obtain the catalyst of the present invention, namely a hollow spherical α-alumina catalyst, wherein the amounts of palladium and iron loaded are 0.25 wt % and 0.13 wt %, respectively, and the loading densities are 1.3 g/L and 0.7 g/L, respectively.

### Evaluation of Catalyst Performance

30 ml of the catalyst of the present invention prepared as described above was charged into a glass reaction tube having an inner diameter of 20 mm and a length of 55 cm, and glass balls were filled in the upper and lower portions thereof. The temperature inside the catalyst layer was controlled at 120° C. A mixed gas consisting of 20 vol % of carbon monoxide, 15 vol % of methyl nitrite, 15 vol % of methanol, 3 vol % of nitric monoxide and 47 vol % of nitrogen was introduced from the upper portion of the reaction tube at a space velocity of 5000/h. The reaction product was brought into contact with methanol to absorb dimethyl oxalates in methanol, and the unabsorbed low boilers were captured by dry ice-methanol condensation. Gas chromatography was used to analyze the mixture of the methanol absorption liquid and the capture liquid obtained after the reaction became stable, and the time-space yield and selectivity of dimethyl oxalate were determined. The results are shown in Table 1.

### Example 2

### Preparation of Catalyst Carrier

Example 1 was repeated except for extruding into hollow cylinders having an inner diameter of 3.3 mm and an outer diameter of 6.5 mm, obtaining a hollow spherical α-alumina carrier having an average pore diameter/average diameter ratio of 0.5, wherein the average diameter is 5 mm, the average pore diameter is 2.5 mm, the specific surface area is 5.3 m²/g, the water absorption rate is 30.1 wt %, and the packing density is 0.75 kg/L.

### Preparation of Catalyst

50 g of the inventive catalyst carrier of Example 2 was impregnated in an equal volume for 2 hours with a mixed impregnating solution prepared by dissolving 0.14 g of palladium chloride and 0.21 g of ferric chloride hexahydrate in 14.6 g of water and 0.08 g of 61% hydrochloric acid with heating, and the other steps were the same as those in Example 1. In this way, a hollow spherical α-alumina catalyst was obtained, wherein the amounts of palladium and iron loaded are 0.17 wt % and 0.09 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Example 3

### Preparation of Catalyst Carrier

Example 1 was repeated except for extruding into hollow cylinders having an inner diameter of 2.0 mm and an outer diameter of 6.5 mm, obtaining a hollow spherical α-alumina carrier having an average pore diameter/average diameter ratio of 0.3, wherein the average diameter is 5 mm, the average pore diameter is 1.5 mm, the specific surface area is 5.3 m²/g, the water absorption rate is 30.1 wt %, and the packing density is 0.91 kg/L.

### Preparation of Catalyst

50 g of the inventive catalyst carrier of Example 3 was impregnated in an equal volume for 2 hours with a mixed impregnating solution prepared by dissolving 0.12 g of palladium chloride and 0.17 g of ferric chloride hexahydrate in 14.7 g of water and 0.07 g of 61% hydrochloric acid with heating, and the other steps were the same as those in Example 1. In this way, a hollow spherical α-alumina catalyst was obtained, wherein the amounts of palladium and iron loaded are 0.14 wt % and 0.07 wt %, respectively, and the loading densities of palladium and iron are 1.3 g/L and 0.7 g/L, respectively.

Evaluation of Catalyst Performance

The evaluation method is the same as that in Example 1, and the results are shown in Table 1.

### Example 4

### Preparation of Catalyst Carrier

Example 1 was repeated except for extruding into hollow cylinders having an inner diameter of 2.7 mm and an outer diameter of 3.9 mm, obtaining a hollow spherical α-alumina carrier having an average pore diameter/average diameter ratio of 0.7, wherein the average diameter is 3 mm, the average pore size is 2.1 mm, the specific surface area is 5.3 m²/g, the water absorption rate is 30.1 wt %, and the packing density is 0.51 kg/L.

### Preparation of Catalyst

50 g of the inventive catalyst carrier of Example 4 was impregnated in an equal volume for 2 hours with a mixed impregnating solution prepared by dissolving 0.21 g of palladium chloride and 0.31 g of ferric chloride hexahydrate in 14.5 g of water and 0.12 g of 61% hydrochloric acid with heating, and the other steps were the same as those in Example 1. In this way, a hollow spherical α-alumina catalyst was obtained, wherein the amounts of palladium and iron loaded are 0.25 wt % and 0.13 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Example 5

### Preparation of Catalyst Carrier

Example 1 was repeated except for replacing the nitric acid used in the kneading with acetic acid, and extruding into hollow cylinders having an inner diameter of 5.1 mm and an outer diameter of 7.3 mm, obtaining a hollow spherical α-alumina carrier having an average pore diameter/average diameter ratio of 0.7, wherein the average diameter is 5.6 mm, the average pore diameter is 3.9 mm, the specific surface area is 10.1 m²/g, the water absorption rate is 40.2 wt %, and the packing density is 0.42 kg/L.

### Preparation of Catalyst

50 g of the inventive catalyst carrier of Example 5 was impregnated in an equal volume for 2 hours with a mixed impregnating solution prepared by dissolving 0.26 g of palladium chloride and 0.39 g of ferric chloride hexahydrate in 19.5 g of water and 0.15 g of 61% hydrochloric acid with heating, and the other steps were the same as those in Example 1. In this way, a hollow spherical α-alumina catalyst was obtained, wherein the amounts of palladium and iron loaded are 0.31 wt % and 0.16 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Example 6

### Preparation of Catalyst Carrier

Example 1 was repeated except for increasing the calcination temperature to 1300° C., obtaining a hollow spherical α-alumina carrier having an average pore diameter/average diameter ratio of 0.7, wherein the average diameter is 4.9 mm, the average pore diameter is 3.4 mm, the specific surface area is 2.8 m²/g, the water absorption rate is 19.7 wt %, and the packing density is 0.58 kg/L.

### Preparation of Catalyst

50 g of the inventive catalyst carrier of Example 6 was impregnated in an equal volume for 2 hours with a mixed impregnating solution prepared by dissolving 0.18 g of palladium chloride and 0.27 g of ferric chloride hexahydrate in 9.4 g of water and 0.11 g of 61% hydrochloric acid with heating, and the other steps were the same as those in Example 1. In this way, a hollow spherical α-alumina catalyst was obtained, wherein the amounts of palladium and iron loaded are 0.22 wt % and 0.11 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Example 7

### Preparation of Catalyst

50 g of the inventive catalyst carrier of Example 1 was impregnated in an equal volume for 2 hours with a mixed impregnating solution prepared by dissolving 0.42 g of palladium chloride and 0.62 g of ferric chloride hexahydrate in 14.0 g of water and 0.24 g of 61% hydrochloric acid with heating, and the other steps were the same as those in Example 1. In this way, a hollow spherical α-alumina catalyst was obtained, wherein the amounts of palladium and iron loaded are 0.50 wt % and 0.26 wt %, respectively, and the loading densities of palladium and iron are 2.6 g/L and 1.3 g/L, respectively.

### Evaluation of Catalyst Performance

The evaluation method is the same as that in Example 1, and the results are shown in Table 1.

### Comparative Example 1

### Preparation of Catalyst Carrier

Example 1 was repeated except that no hollow mold was used for extrusion. In this way, a comparative catalyst carrier, i.e., a spherical α-alumina carrier having only microscopic fine pores, was obtained, wherein the average diameter is 5 mm, the specific surface area was 5.3 m²/g, the water absorption is 30.1 wt % and the packing density is 1.0 kg/L.

### Preparation of Catalyst

50 g of the catalyst carrier of Comparative Example 1 was impregnated in an equal volume for 2 hours with a mixed impregnating solution prepared by dissolving 0.11 g of palladium chloride and 0.16 g of ferric chloride hexahydrate in 14.7 g of water and 0.06 g of 61% hydrochloric acid with heating, and the other steps were the same as those in Example 1. In this way, a hollow spherical α-alumina catalyst was obtained, wherein the amounts of palladium and iron loaded are 0.13 wt % and 0.07 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Comparative Example 2

### Preparation of Catalyst Carrier

Example 1 was repeated except for extruding into hollow cylinders having an inner diameter of 0.7 mm and an outer diameter of 6.5 mm, obtaining a hollow spherical α-alumina carrier having an average pore diameter/average diameter ratio of 0.1, wherein the average diameter is 5 mm, the average pore diameter is 0.5 mm, the specific surface area was 5.3 m²/g, the water absorption rate is 30.1 wt %, and the packing density is 0.99 kg/L.

### Preparation of Catalyst

50 g of the catalyst carrier of Comparative Example 2 was impregnated in an equal volume for 2 hours with a mixed impregnating solution prepared by dissolving 0.11 g of palladium chloride and 0.16 g of ferric chloride hexahydrate in 14.7 g of water and 0.06 g of 61% hydrochloric acid with heating, and the other steps were the same as those in Example 1. In this way, a hollow spherical α-alumina catalyst was obtained, wherein the amounts of palladium and iron loaded are 0.13 wt % and 0.07 wt %, respectively, and the loading densities of palladium and iron are 1.3 g/L and 0.7 g/L, respectively.

### Evaluation of Catalyst Performance

The evaluation method is the same as that in Example 1, and the results are shown in Table 1.

### Comparative Example 3

### Preparation of Catalyst

50 g of the catalyst carrier of Comparative Example 1 was impregnated in an equal volume for 2 hours with a mixed impregnating solution prepared by dissolving 0.22 g of palladium chloride and 0.32 g of ferric chloride hexahydrate in 14.5 g of water and 0.13 g of 61% hydrochloric acid with heating, and the other steps were the same as those in Example 1. In this way, a hollow spherical α-alumina catalyst was obtained, wherein the amounts of palladium and iron loaded are 0.26 wt % and 0.13 wt %, respectively, and the loading densities of palladium and iron are 2.6 g/L and 1.3 g/L, respectively.

### Evaluation of Catalyst Performance

The evaluation method is the same as that in Example 1, and the results are shown in Table 1.

| | Catalyst carrier | | | | | | Catalyst | | | | Catalyst performance | |
|---|---|---|---|---|---|---|---|---|---|---|---|---|
| | | Average | Average | | | | | | Palla- | | Time-space | |
| | | diameter of | pore | Specific | Water | | Palla- | | dium | Iron | yield of | Selectivity |
| | Average | macroscopic | diameter/ | surface | absorption | Packing | dium | Iron | loading | loading | dimethyl | of dimethyl |
| | diameter | large pore | average | area | rate | density | loading | loading | density | density | oxalate | oxalate |
| | mm | mm | diameter | m²/g | % | kg/L | wt % | wt % | g/L | g/L | g/L · h | % |
| Ex. 1 | 5 | 3.5 | 0.7 | 5.3 | 30.1 | 0.51 | 0.25 | 0.13 | 1.3 | 0.7 | 942 | 97.7 |
| Ex. 2 | 5 | 2.5 | 0.5 | 5.3 | 30.1 | 0.75 | 0.17 | 0.09 | 1.3 | 0.7 | 850 | 97.5 |
| Ex. 3 | 5 | 1.5 | 0.3 | 5.3 | 30.1 | 0.91 | 0.14 | 0.07 | 1.3 | 0.7 | 723 | 97.6 |
| Ex. 4 | 3 | 2.1 | 0.7 | 5.3 | 30.1 | 0.51 | 0.25 | 0.13 | 1.3 | 0.7 | 991 | 97.8 |
| Ex. 5 | 5.6 | 3.9 | 0.7 | 10.1 | 40.2 | 0.42 | 0.31 | 0.16 | 1.3 | 0.7 | 928 | 97.9 |
| Ex. 6 | 4.9 | 3.4 | 0.7 | 2.8 | 19.7 | 0.58 | 0.22 | 0.11 | 1.3 | 0.7 | 931 | 97.6 |
| Ex. 7 | 5 | 3.5 | 0.7 | 5.3 | 30.1 | 0.51 | 0.50 | 0.26 | 2.6 | 1.3 | 1189 | 97.4 |
| Com. Ex. 1 | 5 | 0.0 | 0 | 5.3 | 30.1 | 1 | 0.13 | 0.07 | 1.3 | 0.7 | 576 | 97.4 |
| Com. Ex. 2 | 5 | 0.5 | 0.1 | 5.3 | 30.1 | 0.99 | 0.13 | 0.07 | 1.3 | 0.7 | 588 | 97.5 |
| Com. Ex. 3 | 5 | 0.0 | 0 | 5.3 | 30.1 | 1 | 0.26 | 0.13 | 2.6 | 1.3 | 810 | 97.3 |

1. A catalyst carrier for use in the synthesis of dialkyl oxalates by gas-phase catalytic coupling of carbon monoxide comprising microscopic fine pores and one or more macroscopic large pores running through the catalyst carrier, wherein the ratio of the average pore diameter of each macroscopic large pore to the average diameter of the catalyst carrier is 0.2 or more.

2. The catalyst carrier of claim 1, wherein the catalyst carrier has one macroscopic large pore which runs through the catalyst carrier in the form of a straight line.

3. The catalyst carrier of claim 1, wherein the ratio of the average pore diameter of each macroscopic large pore to the average diameter of the catalyst carrier is from 0.5 to 0.8.

4. The catalyst carrier of claim 1, wherein the macroscopic large pore has a circular or elliptical cross-section.

5. The catalyst carrier of claim 1, wherein the catalyst carrier is spherical or ellipsoidal.

6. The catalyst carrier of claim 1, wherein the catalyst carrier has an average diameter of from 1 to 20 mm.

7. The catalyst carrier of claim 1, wherein the catalyst carrier is made of α-alumina, γalumina, silica, silicon carbide, diatomaceous earth, activated carbon, pumice, zeolites, molecular sieves, or titanium dioxide.

8. A catalyst for use in the synthesis of dialkyl oxalates by gas-phase catalytic coupling of carbon monoxide comprising a catalyst carrier, an active component and optionally an auxiliary, supported on the catalyst carrier, wherein the catalyst carrier comprising microscopic fine pores and one or more macroscopic large pores running through the catalyst carrier, wherein the ratio of the average pore diameter of each macroscopic large pore to the average diameter of the catalyst carrier is 0.2 or more.

9. The catalyst of claim 8, wherein the active component is palladium, platinum, ruthenium, rhodium and/or gold, and wherein the auxiliary is iron, nickel, cobalt, cerium, titanium and/or zirconium.

10. The catalyst of claim 8, wherein the active component is in an amount of from 0.1 to 10% by weight, and wherein the auxiliary is in an amount of from 0 to 5% by weight, based on the total weight of the catalyst.

11. The catalyst of claim 8, wherein the catalyst carrier has one macroscopic large pore which runs through the catalyst carrier in the form of a straight line.

12. The catalyst of claim 8, wherein the ratio of the average pore diameter of each macroscopic large pore to the average diameter of the catalyst carrier is from 0.5 to 0.8.

13. The catalyst of claim 8, wherein the macroscopic large pore has a circular or elliptical cross-section.

14. The catalyst of claim 8, wherein the catalyst carrier is spherical or ellipsoidal.

15. The catalyst of claim 8, wherein the catalyst carrier has an average diameter of from 1 to 20 mm.

16. The catalyst of claim 8, wherein the catalyst carrier is made of α-alumina, γ-alumina, silica, silicon carbide, diatomaceous earth, activated carbon, pumice, zeolites, molecular sieves, or titanium dioxide.

17. The catalyst carrier of claim 7, wherein the catalyst carrier is made of α-alumina.

18. The catalyst of claim 16, wherein the catalyst carrier is made of α-alumina.

19. The catalyst carrier of claim 2, wherein the ratio of the average pore diameter of each macroscopic large pore to the average diameter of the catalyst carrier is from 0.5 to 0.8.

20. The catalyst carrier of claim 9, wherein the active component is in an amount of from 0.1 to 10% by weight, and wherein the auxiliary is in an amount of from 0 to 5% by weight, based on the total weight of the catalyst.
